(19) United States
(12) Patent Application Publication
(10) Pub. No.: US 2016/0134836 A1
(43) Pub. Date: May 12, 2016

(54) IMAGE SUPPLY DEVICE, IMAGE SUPPLY METHOD, AND COMPUTER-READABLE STORAGE MEDIUM

(71) Applicant: Seiko Epson Corporation, Tokyo (JP)

(72) Inventor: Takayuki Shimizu, Matsumoto-shi (JP)

(21) Appl. No.: 14/925,766

(22) Filed: Oct. 28, 2015

(30) Foreign Application Priority Data
Nov. 7, 2014 (JP) 2014-227370

(51) Int. Cl. H04N 7/14; H04N 19/115; H04N 19/136; H04N 5/232; H04N 7/15

(52) U.S. Cl. CPC H04N 7/147; H04N 5/23206; H04N 7/155; H04N 19/136; H04N 19/115

(57) ABSTRACT

An image supply device includes: a first acquisition unit which acquires an image; a second acquisition unit which acquires information indicating a transmission capacity of a communication channel used for transmission of the image; an analysis unit which analyzes the image acquired by the first acquisition unit; a setting unit which sets a communication condition for transmitting the image and a parameter for compressing the image, according to an analysis result of the image and the transmission capacity of a communication channel; and a transmission unit which transmits the image compressed using the parameter, according to the communication condition.

The entire disclosure of Japanese Patent Application No. 2014-227370, filed Nov. 7, 2014, is expressly incorporated by reference herein.

### BACKGROUND

1. Technical Field

The present invention relates to an image supply device, an image supply method, and a computer-readable storage medium.

2. Related Art

In a system where image data is transmitted and received between a transmitting-side terminal and a receiving-side terminal via a network so that an image is displayed on the receiving-side terminal, a technique for preventing the occurrence of a data loss or transmission delay due to a shortage of band is proposed. For example, JP-A-2014-49942 discloses a technique in which, in a projection system using a PC and a projector, the communication status between the PC and the projector is detected and the data volume per unit time (transmission interval, image compression method, resolution or the like) of image data transmitted from the PC to the projector is changed on the basis of the result of the detection.

The technique disclosed in JP-A-2014-49942 has a problem that the band cannot be effectively used because the data volume of image data transmitted per unit time is decided regardless of the size of the image to be transmitted.

### SUMMARY

An advantage of some aspect of the invention is to provide a technique for more effective use of the transmission capacity of a communication channel used for transmission of an image.

An aspect of the invention provides an image supply device including: a first acquisition unit which acquires an image; a second acquisition unit which acquires information indicating a transmission capacity of a communication channel used for transmission of the image; an analysis unit which analyzes the image acquired by the first acquisition unit; a setting unit which sets a communication condition for transmitting the image and a parameter for compressing the image, according to an analysis result of the image and the transmission capacity; and a transmission unit which transmits the image compressed using the parameter, according to the communication condition. According to this image supply device, the transmission capacity of the communication channel used for transmission of the image can be used more effectively than in the case where the communication condition and the parameter are not set according to the analysis result of the image.

The image supply device may include a compression unit which compresses the image, using the parameter. The analysis unit may analyze the image compressed by the compression unit. According to this image supply device, the transmission capacity of the communication channel used for transmission of the image can be used more effectively than in the case where the communication condition and the parameter are not set according to the analysis result of the compressed image.

The compression unit may compress an area of a compression target image where a change is made from an image transmitted immediately before this image. According to this image supply device, the data volume of the image to be transmitted can be restrained, compared with the case where the compression target image is compressed in its entirety.

The setting unit may set the parameter within a range between a predetermined upper limit value and lower limit value. According to this image supply device, the image is compressed more properly than in the case where the upper limit value and the lower limit value of the parameter are not decided.

The setting unit may decide at least one of the upper limit value and the lower limit value according to an attribute of the image. According to this image supply device, the image is compressed with a degree corresponding to the attribute of the image.

The setting unit may set the number of times the image is transmitted per unit time, as the communication condition. According to this image supply device, the transmission capacity of the communication channel used for transmission of the image can be used more effectively than in the case where the number of times the image is transmitted per unit time is not set according to the analysis result of the compressed image.

The image supply device may include a detection unit which detects the transmission capacity. The second acquisition unit may acquire the information from the detection unit. According to this image supply device, the image is transmitted using the detected transmission capacity.

Another aspect of the invention provides an image supply method including: acquiring an image; acquiring information indicating a transmission capacity of a communication channel used for transmission of the image; analyzing the acquired image; setting a communication condition for transmitting the image and a parameter for compressing the image, according to an analysis result of the image and the transmission capacity; and transmitting the image compressed using the parameter, according to the communication condition. According to this image supply method, the transmission capacity of the communication channel used for transmission of the image can be used more effectively than in the case where the communication condition and the parameter are not set according to the analysis result of the image.

Still another aspect of the invention provides a computer-readable storage medium storing a program, the program causing a computer to execute: acquiring an image; acquiring information indicating a transmission capacity of a communication channel used for transmission of the image; analyzing the acquired image; setting a communication condition for transmitting the image and a parameter for compressing the image, according to an analysis result of the image and the transmission capacity; and transmitting the image compressed using the parameter, according to the communication condition. According to this program, the transmission capacity of the communication channel used for transmission of the image can be used more effectively than in the case where the communication condition and the parameter are not set according to the analysis result of the image.

### BRIEF DESCRIPTION OF THE DRAWINGS

The invention will be described with reference to the accompanying drawings, wherein like numbers reference like elements.

FIG. 1 is a schematic view of a display system according to an embodiment.

FIG. 2 shows the functional configuration of a PC according to an embodiment.

FIG. 3 illustrates the hardware configuration of the PC.

FIG. 4 is a flowchart showing the operations of the PC.

FIGS. 5A and 5B illustrate an updated area.

### DESCRIPTION OF EXEMPLARY EMBODIMENTS

### 1. Configuration

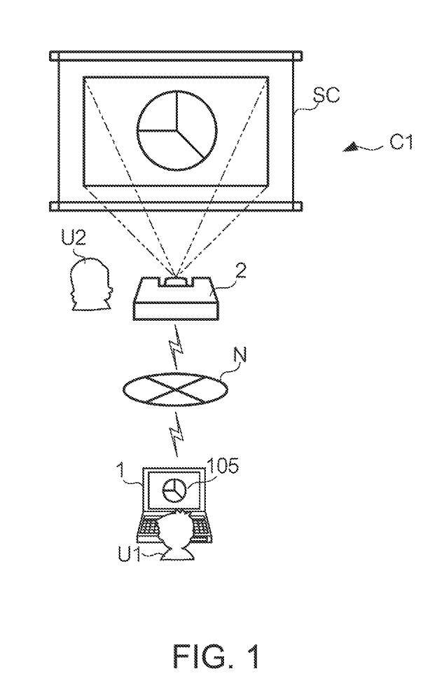

FIG. 1 is a schematic view of a display system C1 according to an embodiment of the invention. The display system C1 is used for a conference attended by a plurality of users at remote locations. The display system C1 has a personal computer 1 (hereinafter referred to as “PC 1”) and a projector 2. In FIG. 1, the PC 1 and the projector 2 are provided at different places from each other and communicate with each other via a network N such as the internet. In the example of FIG. 1, the PC 1 and the projector 2 are wirelessly connected to the network N. The PC 1 is an image supply device which transmits a video signal to the projector 2. In the display system C1, the PC 1 transmits an image displayed on a display unit 105 of the PC 1 itself, to the projector 2. The projector 2 is an image display device which projects an image indicated by a video signal, onto a screen SC. In the display system C1, the projector 2 projects the image transmitted from the PC 1 onto the screen SC. In the example of FIG. 1, the PC 1 is used by a user U1 and the projector 2 is used by a user U2.

In the display system C1, there are cases where synchronization between the PC 1 and the projector 2 cannot be achieved due to a limitation on the bans (transmission capacity of the communication channel). In such cases, a time lag occurs between the image displayed on the display unit 105 of the PC 1 and the image projected on the screen SC, and the image projected on the screen SC may not be smooth. The PC 1 copes with such problems by changing the number of times the image is transmitted per unit time and the image quality of the image to be transmitted, according to the size and band of the image to be transmitted.

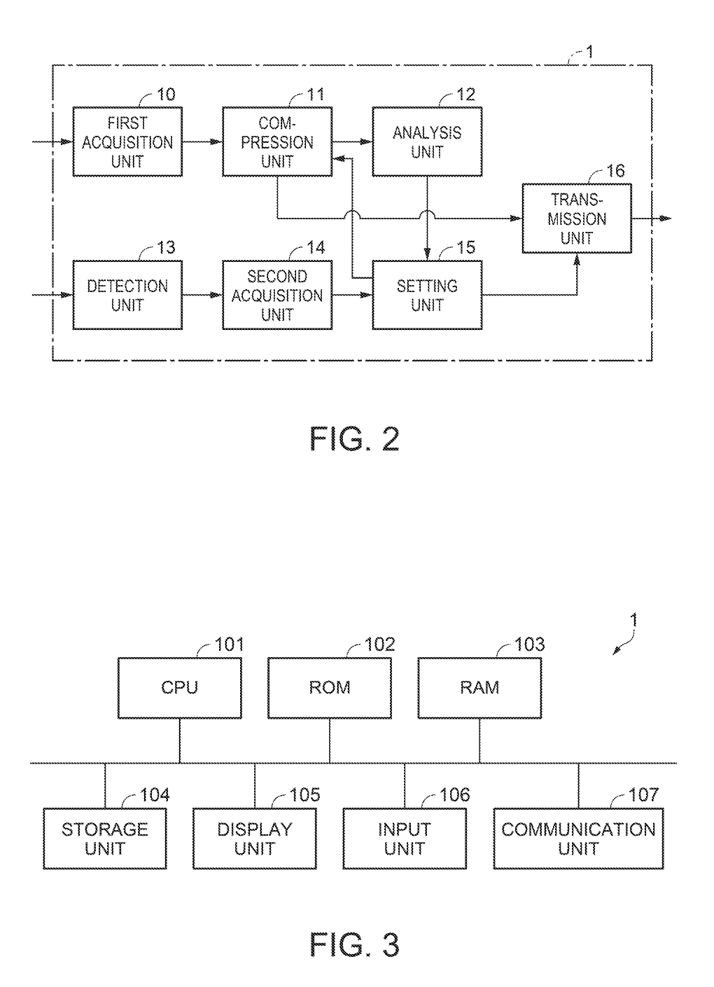

FIG. 2 shows the functional configuration of the PC 1 according to an embodiment. The PC 1 has a first acquisition unit 10, a compression unit 11, an analysis unit 12, a detection unit 13, a second acquisition unit 14, a setting unit 15, and a transmission unit 16. The first acquisition unit 10 acquires an image. The compression unit 11 compresses the image acquired by the first acquisition unit 10. The compression unit 11 compresses the image, using a parameter set by the setting unit 15. The analysis unit 12 analyzes the image compressed by the compression unit 11. The detection unit 13 detects a band used for transmission of the image. The second acquisition unit 14 acquires information indicating the bans used for transmission of the image. The setting unit 15 sets a communication condition for transmitting the image and a parameter for compressing the image, according to the analysis result of the image by the analysis unit 12 and the band indicated by the information acquired by the second acquisition unit 14. The transmission unit 16 transmits the image compressed by the compression unit 11, according to the communication condition set by the setting unit 15.

FIG. 3 illustrates the hardware configuration of the PC 1 according to an embodiment. The PC 1 is a computer having a CPU (central processing unit) 101, a ROM (read only memory) 102, a RAM (random access memory) 103, a storage unit 104, a display unit 105, an input unit 106, and a communication unit 107. The CPU 101 reads out a program stored in the ROM 102 and the storage unit 104 and executes the program using the RAM 103 as a work area. The ROM 102 is a non-volatile storage device in which various programs and data are stored. The RAM 103 is a volatile storage device which stores data.

The storage unit 104 is a non-volatile storage device which stores data and programs, for example, an HDD (hard disk drive) or SSD (solid state drive). In this example, the storage unit 104 stores a program for transmitting an image to an external device via a network (hereinafter referred to as “conference program”).

The display unit 105 has a display device such as a liquid crystal display or organic EL (electroluminescence) display. The input unit 106 is a device for accepting operation inputs by the user and includes a keyboard, a mouse, and various buttons or the like.

The communication unit 107 is a unit for transmitting and receiving data. The communication unit 107 functions as a communication interface to communicate with an external device such as the projector 2 via a network.

In this example, the CPU 101 executing the conference program is an example of the first acquisition unit 10, the compression unit 11, the analysis unit 12, the detection unit 13, the second acquisition unit 14, the setting unit 15 and the transmission unit 16.

### 2. Operations

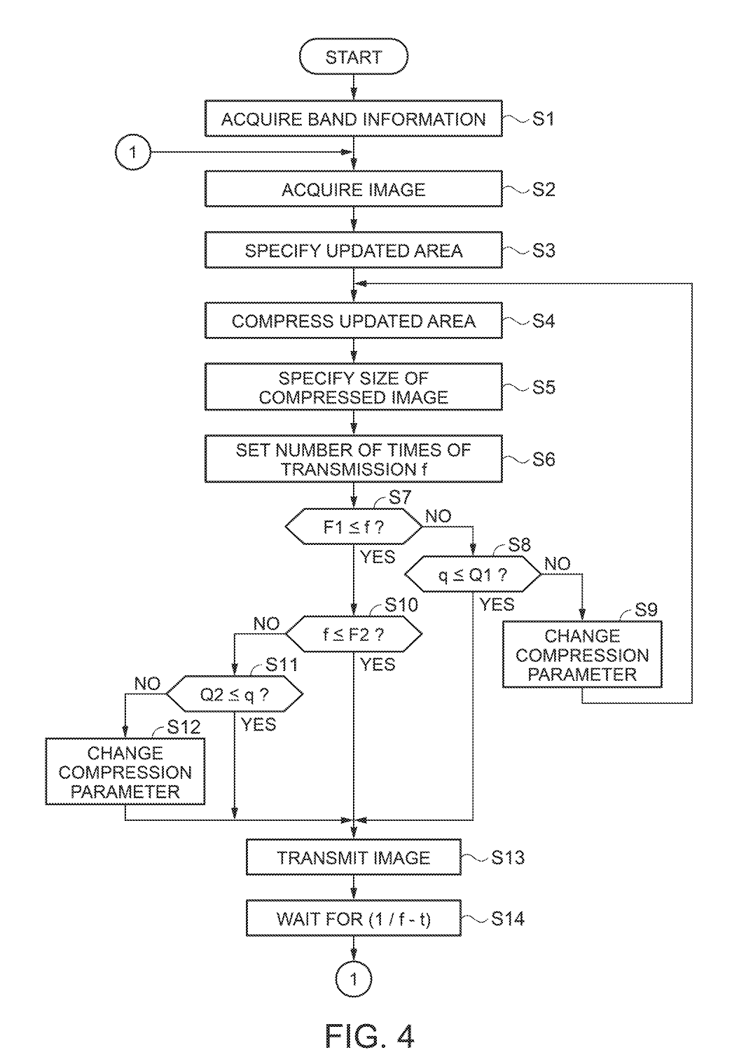

FIG. 4 is a flowchart showing the operations of the PC 1 according to an embodiment. The processing below starts, triggered by the startup of the conference program. The PC 1 and the projector 2 are connected together in advance via the network N before the processing of FIG. 4 starts. In the description below, the conference program may be described as the agent of an operation, which means that the CPU 101 executing this program performs processing in collaboration with other hardware elements.

In Step S1, the conference program acquires information indicating a band used for transmission of an image (hereinafter referred to as “band information”). The conference program, for example, displays band candidates on the display unit 105 and accepts the selection of a band by the user U1, thereby acquiring band information. In Step S2, the conference program acquires the image displayed on the display unit 105. The conference program stores the acquired image (hereinafter referred to as “captured image”) in the RAM 103. In this embodiment, a newly acquired captured image and a captured image immediately before this captured image are stored in the RAM 103.

In Step S3, the conference program specifies an area where there is a change from the captured image immediately before this captured image (hereinafter referred to as “updated area”), in the captured image newly acquired in Step S2. Specifically, the conference program compares the two captured images stored in the RAM 103, extracts the difference, and specifies an area including this difference as an updated area. When the processing of Step S3 is performed for the first time after the conference program is started, the conference program specifies the entirety of the captured image as an updated area. The conference program stores the specified updated area in the RAM.

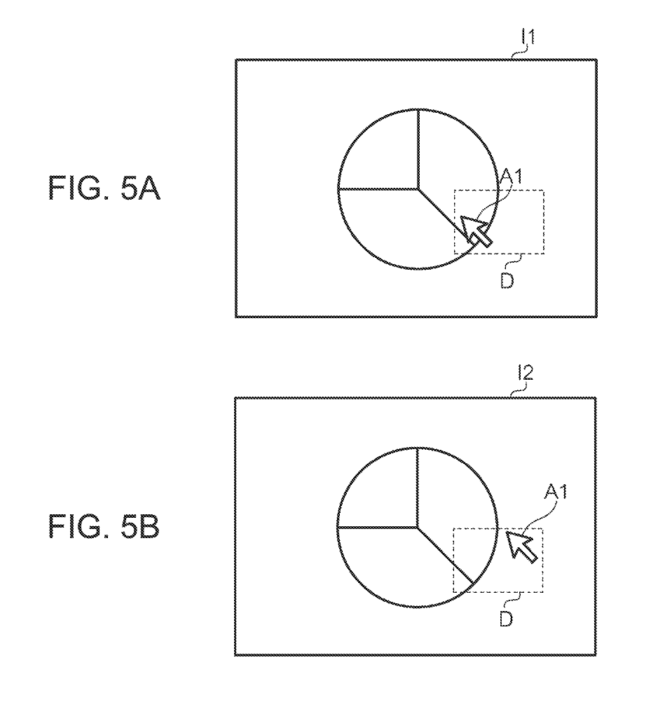

FIGS. 5A and 5B illustrate an updated area. In this example, an image I is displayed on the display unit 105 as software for presentation is executed. FIG. 5A shows an image I1 of the present frame. FIG. 5B shows an image I2 of the previous frame (frame immediately before the present frame). The frames here refer to individual still images forming a video. As shown in FIGS. 5A and 5B, the user U1 moves a cursor A1 in an area D by operating the mouse. In this case, the conference program specifies the area D as an updated area.

Referring to FIG. 4 again, in Step S4, the conference program compresses the updated area in the captured image, using a predetermined parameter (hereinafter referred to as “compression parameter”). The compression parameter is a parameter used for compression of the image. The compression rate of the image changes according to the value of the compression parameter. That is, the size of the image after the compression (hereinafter referred to as “compressed image”) changes. An initial value is set for the compression parameter and the parameter value is changed by the processing of Steps S9 and S12, described later. The conference program stores the compressed image in the RAM 103.

In Step S5, the conference program analyzes the compressed image and specifies the size of the compressed image. In Step S6, the conference program sets the number of times f the image is transmitted per unit time (hereinafter referred to as “number of times of transmission f”) as a communication condition. The number of times of transmission f is calculated by the following equation (1).

f=Bw/Sz (1)

In this equation, Bw represents the band indicated by the band information acquired in Step S1. Sz represents the size of the compressed image specified in Step S5. The conference program specifies the calculated number of times of transmission f as a communication condition.

In Step S7, the conference program determines whether the number of times of transmission f is equal to or above a threshold F1, or not. The threshold F1 is a lower limit value of the number of times of transmission f and set in advance in the conference program. If the number of times of transmission f is determined as being below the threshold F1 (S7: NO), the conference program shifts the processing to Step S8. If the number of times of transmission f is determined as being equal to or above the threshold F1 (S7: YES), the conference program shifts the processing to Step S10.

In Step S8, the conference program determines whether the image quality q of the compressed image is equal to or below a threshold Q1, or not. The image quality q is a value indicating the image quality of the compressed image (for example, the resolution or number of gradations of the compressed image) and is specified by the conference program analyzing the compressed image. The threshold value Q1 is a lower limit value of the image quality q and set in advance in the conference program. If the image quality q is determined as being above the threshold Q1 (S8: NO), the conference program shifts the processing to Step S9. If the image quality q is determined as being equal to or below the threshold Q1 (S8: YES), the conference program shifts the processing to Step S13.

In Step S9, the conference program changes the compression parameter. Specifically, the conference program changes the value of the compression parameter in such a way that the image quality q of the compressed image drops by a predetermined level. The processing of Step S9 is performed in order to reset the number of times of transmission f so as to satisfy the determination condition “F1≦f” in Step S7. As the processing of Step S9 ends, the conference program shifts the processing to Step S4 again and compresses the updated area again, using the changed compressed parameter. In this case, since the size of the compressed image decreases because of the drop in the image quality of the compressed image, the number of times of transmission f reset in Step S6 increases.

In Step 10, the conference program determines whether the number of times of transmission f is equal to or below a threshold F2, or not. The threshold F2 is an upper limit value of the number of times of transmission f and set in advance in the conference program. If the number of times of transmission f is determined as being above the threshold F2 (S10: NO), the conference program shifts the processing to Step S11. If the number of times of transmission f is determined as being equal to or below the threshold F2 (S10: YES), the conference program shifts the processing to Step S13.

In Step S11, the conference program determines whether the image quality q of the compressed image is equal to or above a threshold Q2, or not. The threshold Q2 is an upper limit value of the image quality q and set in advance in the conference program. If the image quality q is determined as being below the threshold Q2 (S11: NO), the conference program shifts the processing to Step S12. If the image quality q is determined as being equal to or above the threshold Q2 (S11: YES), the conference program shifts the processing to Step S13.

In Step S12, the conference program changes the compression parameter. Specifically, the conference program changes the value of the compression parameter in such a way that the image quality q of the compressed image rises by a predetermined level. The processing of Step S12 is performed in order to set the number of times of transmission f so as to satisfy the determination condition “f≦F2” in Step S10. As the processing of Step S12 ends, the conference program shifts the processing to Step S13. Therefore, in the case where the processing of Step S12 is preformed, the changed compression parameter is used when the next captured image is compressed. In this case, since the size of the compressed image increases because of the rise in the image quality of the compressed image, the number of times of transmission f set next in Step S6 decreases.

In Step S13, the conference program transmits the compressed image to the projector 2. In Step S14, the conference program waits until a time T passes. The time T is calculated by the following equation (2). The processing of Step S14 is performed in order to achieve control so that the image is transmitted with the number of times of transmission f calculated in Step S6.

T=(1/f)−t (2)

In the equation (2), f represents the number of times of transmission f calculated in Step S6, and t represents the time taken from the start of the processing of Step S2 to the start of the processing of Step S13. The conference program measures this time taken, in the course of performing the processing of Steps S2 to S13. As the processing of Step S14 ends, the conference program shifts the processing to Step S2 again.

By the above processing, the communication condition and the image quality of the image to be transmitted are adjusted according to the size of the image to be transmitted and the band. Therefore, the band is used more effectively and the synchronization between the PC 1 and the projector 2 is achieved more easily than in the case where the communication condition and the image quality are adjusted regardless of the size of the image to be transmitted.

### 3. Modifications

The invention is not limited to the embodiment and various modifications are possible. Several modifications will be described below. Of the following descriptions, two or more may be combined.

The devices used in the display system C1 are not limited to the devices described in the embodiment. For example, a tablet terminal such as a smartphone, or a DVD (digital versatile disk) player may be used as an image supply device. As an alternative example, a direct-view display device may be used as an image display device.

The thresholds Q1 and Q2 are not limited to fixed values. At least one of the thresholds Q1 and Q2 may be decided according to an attribute of the image to be transmitted, such as the type of the software which displays the image as the source of a captured image (hereinafter referred to as “source image”), on the display unit 105. For example, if the source image is displayed as software for presentation is executed, the thresholds Q1 and Q2 may be set to be relatively low, whereas if the source image is displayed as software for drawing is executed, the thresholds Q1 and Q2 may be set to be relatively high. In this case, at the time of presentation, the image projected on the screen SC is smoother than at the time of drawing, and at the time of drawing, the image quality of the image projected on the screen SC is higher than at the time of presentation.

The method for the conference program to acquire the band information is not limited to the method described in the embodiment. The conference program may detect the band information in the course of communication between the image supply device and the image display device. For example, if audio communication is carried out between the image supply device and the image display device via the network N, the band information may be detected by including predetermined test data in an audio packet and measuring the time taken for the test data to shuttle between the image supply device and the image display device. In this case, the detection of the band information is carried out periodically and the communication condition is set using the detected band information.

The circumstance where the invention is utilized is not limited to teleconferencing. The invention may be utilized to the case where the PC 1 and the projector 2 are provided in the same place.

The communication condition set by the conference program is not limited to the number of times of transmission. For example, the conference program may set the transmission interval of the image as a communication condition.

The conference program may be provided in the state of being stored in a computer-readable storage medium such as a magnetic storage medium (magnetic tape, magnetic disk (HDD, FD (flexible disk)) or the like), optical storage medium (optical disk (CD (compact disk), DVD) or the like), magneto-optical storage medium, or semiconductor memory (flash ROM or the like). This program may also be downloaded via a network such as the internet.

What is claimed is:

1. An image supply device comprising:
a first acquisition unit which acquires an image;
a second acquisition unit which acquires information indicating a transmission capacity of a communication channel used for transmission of the image;
an analysis unit which analyzes the image acquired by the first acquisition unit;
a setting unit which sets a communication condition for transmitting the image and a parameter for compressing the image, according to an analysis result of the image and the transmission capacity; and
a transmission unit which transmits the image compressed using the parameter, according to the communication condition.

2. The image supply device according to claim 1, comprising a compression unit which compresses the image, using the parameter,
wherein the analysis unit analyzes the image compressed by the compression unit.

3. The image supply device according to claim 2, wherein the compression unit compresses an area of a compression target image where a change is made from an image transmitted immediately before this image.

4. The image supply device according to claim 1, wherein
the setting unit sets the parameter within a range between a predetermined upper limit value and lower limit value.

5. The image supply device according to claim 4, wherein
the setting unit decides at least one of the upper limit value and the lower limit value according to an attribute of the image.

6. The image supply device according to claim 1, wherein
the setting unit sets the number of times the image is transmitted per unit time, as the communication condition.

7. The image supply device according to claim 1, comprising a detection unit which detects the transmission capacity,
wherein the second acquisition unit acquires the information from the detection unit.

8. An image supply method comprising:
acquiring an image;
acquiring information indicating a transmission capacity of a communication channel used for transmission of the image;
analyzing the acquired image;
setting a communication condition for transmitting the image and a parameter for compressing the image, according to an analysis result of the image and the transmission capacity; and
transmitting the image compressed using the parameter, according to the communication condition.

9. A computer-readable storage medium storing a program, the program causing a computer to execute:
acquiring an image;
acquiring information indicating a transmission capacity of a communication channel used for transmission of the image;
analyzing the acquired image;
setting a communication condition for transmitting the image and a parameter for compressing the image, according to an analysis result of the image and the transmission capacity; and
transmitting the image compressed using the parameter, according to the communication condition.
